(19) United States
(12) Patent Application Publication
(10) Pub. No.: US 2014/0111138 A1
(43) Pub. Date: Apr. 24, 2014

(54) POSITION-BASED CAR MODE ACTIVATION

(71) Applicant: QUALCOMM INCORPORATED, San Diego, CA (US)

(72) Inventors: Andrew C. Heckford, Cambridge (GB); Peter Andic, Cambridge (GB); Michael L. Tunmer, Cambridge (GB)

(73) Assignee: Qualcomm Incorporated, San Diego, CA (US)

(21) Appl. No.: 13/655,304

(22) Filed: Oct. 18, 2012

(51) Int. Cl. H02J 7/00

(52) U.S. Cl. 320/106

(57) ABSTRACT

A system for transferring power wirelessly for charging a device is provided. The system includes a detector configured to detect a chargeable device, the chargeable device having an available functionality and configured to initiate a charging request. The system further includes a wireless power transmitter configured to transmit power wirelessly to the chargeable device at a level sufficient to charge or power the chargeable device. The system further includes a processor configured to determine a type of user associated with the chargeable device and to configure the available functionality of the chargeable device based on the determined type of user and in response to the charging request.

### FIELD

The present invention relates generally to wireless power. More specifically, the disclosure is directed to charging a device wirelessly in a vehicle.

### BACKGROUND

An increasing number and variety of electronic devices are powered via rechargeable batteries. Such devices include mobile phones, portable music players, laptop computers, tablet computers, computer peripheral devices, communication devices (e.g., Bluetooth devices), digital cameras, hearing aids, and the like. While battery technology has improved, battery-powered electronic devices increasingly require and consume greater amounts of power, thereby often requiring recharging. Rechargeable devices are often charged via wired connections through cables or other similar connectors that are physically connected to a power supply. Cables and similar connectors may sometimes be inconvenient or cumbersome and have other drawbacks. Wireless charging systems that are capable of transferring power in free space to be used to charge rechargeable electronic devices or provide power to electronic devices may overcome some of the deficiencies of wired charging solutions. As such, wireless power transfer systems and methods that efficiently and safely transfer power to electronic devices are desirable.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides a system for transferring power wirelessly for charging a chargeable device. The system includes a detector configured to detect the chargeable device, the chargeable device having an available functionality and configured to initiate a charging request. The system further includes a wireless power transmitter operationally coupled to the detector and configured to transmit power wirelessly to the chargeable device at a level sufficient to charge or power the chargeable device. The system further includes a processor configured to determine a type of user associated with the chargeable device and to configure the available functionality of the chargeable device based on the determined type of user and in response to the charging request.

Another aspect of the disclosure provides a method of transferring power wirelessly for charging a chargeable device. The method includes detecting the chargeable device, the chargeable device having an available functionality and configured to initiate a charging request. The method further includes transmitting power wirelessly to the chargeable device at a level sufficient to charge or power the chargeable device. The method further includes determining a type of user associated with the chargeable device. The method further includes configuring the available functionality of the chargeable device based on the determined type of user and in response to the charging request.

Another aspect of the disclosure provides an apparatus for transferring power wirelessly for charging a chargeable device. The apparatus includes means for detecting the chargeable device, the chargeable device having an available functionality and configured to initiate a charging request. The apparatus further includes means for transmitting power wirelessly to the chargeable device at a level sufficient to charge or power the chargeable device. The apparatus further includes means for determining a type of user associated with the chargeable device. The apparatus further includes means for configuring the available functionality of the chargeable device based on the determined type of user and in response to the charging request.

Another aspect of the disclosure provides a non-transitory computer-readable medium comprising code that, when executed, causes an apparatus to detect a chargeable device, the chargeable device having an available functionality and configured to initiate a charging request. The medium further comprises code that, when executed, causes an apparatus to transmit power wirelessly to the chargeable device at a level sufficient to charge or power the chargeable device. The medium further comprises code that, when executed, causes an apparatus to determine a type of user associated with the chargeable device. The medium further includes code that, when executed, causes an apparatus to configure the available functionality of the chargeable device based on the determined type of user and in response to the charging request.

### BRIEF DESCRIPTION OF THE DRAWINGS

FIG. 1 is a functional block diagram of an exemplary wireless power transfer system, in accordance with exemplary embodiments of the invention.

FIG. 2 is a functional block diagram of exemplary components that may be used in the wireless power transfer system of FIG. 1, in accordance with various exemplary embodiments of the invention.

FIG. 3 is a schematic diagram of a portion of transmit circuitry or receive circuitry of FIG. 2 including a transmit or receive coil, in accordance with exemplary embodiments of the invention.

FIG. 4 is a functional block diagram of a transmitter that may be used in the wireless power transfer system of FIG. 1, in accordance with exemplary embodiments of the invention.

FIG. 5 is a functional block diagram of a receiver that may be used in the wireless power transfer system of FIG. 1, in accordance with exemplary embodiments of the invention.

FIG. 6 is a schematic diagram of a portion of transmit circuitry that may be used in the transmit circuitry of FIG. 4.

FIG. 7 is a block diagram of an embodiment of a communications system.

FIGS. 8A-C is a schematic diagram of an embodiment of an interior of a vehicle.

FIG. 9 is a schematic diagram of an embodiment of a vehicle.

FIG. 10 is a flowchart of an exemplary method of transferring power wirelessly for charging.

FIG. 11 is a functional block diagram of a wireless power and communications system, in accordance with an exemplary embodiment of the invention.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The detailed description set forth below in connection with the appended drawings is intended as a description of exemplary embodiments of the invention and is not intended to represent the only embodiments in which the invention may be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. In some instances, some devices are shown in block diagram form.

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a “receiving coil” to achieve power transfer.

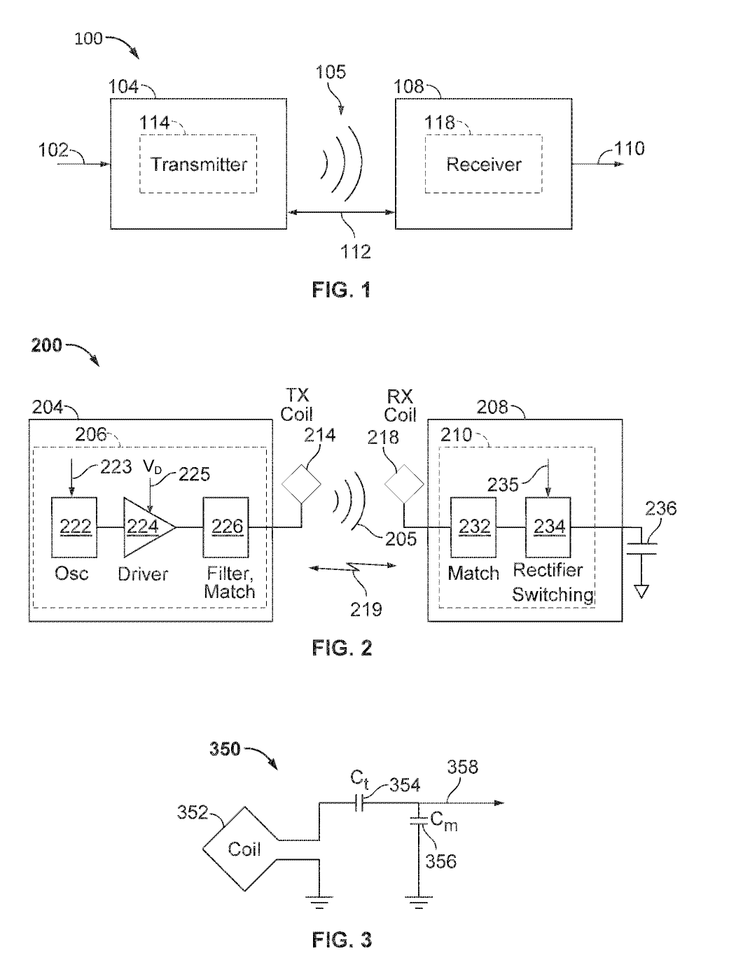

FIG. 1 is a functional block diagram of an exemplary wireless power transfer system 100, in accordance with exemplary embodiments of the invention. Input power 102 may be provided to a transmitter 104 from a power source (not shown) for generating a field 105 for providing energy transfer. A receiver 108 may couple to the field 105 and generate output power 110 for storing or consumption by a device (not shown) coupled to the output power 110. Both the transmitter 104 and the receiver 108 are separated by a distance 112. In one exemplary embodiment, transmitter 104 and receiver 108 are configured according to a mutual resonant relationship. When the resonant frequency of receiver 108 and the resonant frequency of transmitter 104 are substantially the same or very close, transmission losses between the transmitter 104 and the receiver 108 are minimal. As such, wireless power transfer may be provided over larger distance in contrast to purely inductive solutions that may require large coils that require coils to be very close (e.g., mms). Resonant inductive coupling techniques may thus allow for improved efficiency and power transfer over various distances and with a variety of inductive coil configurations.

The receiver 108 may receive power when the receiver 108 is located in an energy field 105 produced by the transmitter 104. The field 105 corresponds to a region where energy output by the transmitter 104 may be captured by a receiver 105. In some cases, the field 105 may correspond to the “near-field” of the transmitter 104 as will be further described below. The transmitter 104 may include a transmit coil 114 for outputting an energy transmission. The receiver 108 further includes a receive coil 118 for receiving or capturing energy from the energy transmission. The near-field may correspond to a region in which there are strong reactive fields resulting from the currents and charges in the transmit coil 114 that minimally radiate power away from the transmit coil 114. In some cases the near-field may correspond to a region that is within about one wavelength (or a fraction thereof) of the transmit coil 114. The transmit and receive coils 114 and 118 are sized according to applications and devices to be associated therewith. As described above, efficient energy transfer may occur by coupling a large portion of the energy in a field 105 of the transmit coil 114 to a receive coil 118 rather than propagating most of the energy in an electromagnetic wave to the far field. When positioned within the field 105, a “coupling mode” may be developed between the transmit coil 114 and the receive coil 118. The area around the transmit and receive coils 114 and 118 where this coupling may occur is referred to herein as a coupling-mode region.

FIG. 2 is a functional block diagram of exemplary components that may be used in the wireless power transfer system 100 of FIG. 1, in accordance with various exemplary embodiments of the invention. The transmitter 204 may include transmit circuitry 206 that may include an oscillator 222, a driver circuit 224, and a filter and matching circuit 226. The oscillator 222 may be configured to generate a signal at a desired frequency, such as 468.75 KHz, 6.78 MHz or 13.56 MHz, that may be adjusted in response to a frequency control signal 223. The oscillator signal may be provided to a driver circuit 224 configured to drive the transmit coil 214 at, for example, a resonant frequency of the transmit coil 214. The driver circuit 224 may be a switching amplifier configured to receive a square wave from the oscillator 222 and output a sine wave. For example, the driver circuit 224 may be a class E amplifier. A filter and matching circuit 226 may be also included to filter out harmonics or other unwanted frequencies and match the impedance of the transmitter 204 to the transmit coil 214.

The receiver 208 may include receive circuitry 210 that may include a matching circuit 232 and a rectifier and switching circuit 234 to generate a DC power output from an AC power input to charge a battery 236 as shown in FIG. 2 or to power a device (not shown) coupled to the receiver 108. The matching circuit 232 may be included to match the impedance of the receive circuitry 210 to the receive coil 218. The receiver 208 and transmitter 204 may additionally communicate on a separate communication channel 219 (e.g., Bluetooth, zigbee, cellular, etc). The receiver 208 and transmitter 204 may alternatively communicate via in-band signaling using characteristics of the wireless field 206.

As described more fully below, receiver 208, that may initially have a selectively disablable associated load (e.g., battery 236), may be configured to determine whether an amount of power transmitted by transmitter 204 and receiver by receiver 208 is appropriate for charging a battery 236. Further, receiver 208 may be configured to enable a load (e.g., battery 236) upon determining that the amount of power is appropriate. In some embodiments, a receiver 208 may be configured to directly utilize power received from a wireless power transfer field without charging of a battery 236. For example, a communication device, such as a near-field communication (NFC) or radio-frequency identification device (RFID may be configured to receive power from a wireless power transfer field and communicate by interacting with the wireless power transfer field and/or utilize the received power to communicate with a transmitter 204 or other devices.

FIG. 3 is a schematic diagram of a portion of transmit circuitry 206 or receive circuitry 210 of FIG. 2 including a transmit or receive coil 352, in accordance with exemplary embodiments of the invention. As illustrated in FIG. 3, transmit or receive circuitry 350 used in exemplary embodiments may include a coil 352. The coil may also be referred to or be configured as a “loop” antenna 352. The coil 352 may also be referred to herein or be configured as a “magnetic” antenna or an induction coil. The term “coil” is intended to refer to a component that may wirelessly output or receive energy for coupling to another “coil.” The coil may also be referred to as an “antenna” of a type that is configured to wirelessly output or receive power. The coil 352 may be configured to include an air core or a physical core such as a ferrite core (not shown). Air core loop coils may be more tolerable to extraneous physical devices placed in the vicinity of the core. Furthermore, an air core loop coil 352 allows the placement of other components within the core area. In addition, an air core loop may more readily enable placement of the receive coil 218 (FIG. 2) within a plane of the transmit coil 214 (FIG. 2) where the coupled-mode region of the transmit coil 214 (FIG. 2) may be more powerful.

As stated, efficient transfer of energy between the transmitter 104 and receiver 108 may occur during matched or nearly matched resonance between the transmitter 104 and the receiver 108. However, even when resonance between the transmitter 104 and receiver 108 are not matched, energy may be transferred, although the efficiency may be affected. Transfer of energy occurs by coupling energy from the field 105 of the transmitting coil to the receiving coil residing in the neighborhood where this field 105 is established rather than propagating the energy from the transmitting coil into free space.

The resonant frequency of the loop or magnetic coils is based on the inductance and capacitance. Inductance may be simply the inductance created by the coil 352, whereas, capacitance may be added to the coil's inductance to create a resonant structure at a desired resonant frequency. As a non-limiting example, capacitor 352 and capacitor 354 may be added to the transmit or receive circuitry 350 to create a resonant circuit that selects a signal 356 at a resonant frequency. Accordingly, for larger diameter coils, the size of capacitance needed to sustain resonance may decrease as the diameter or inductance of the loop increases. Furthermore, as the diameter of the coil increases, the efficient energy transfer area of the near-field may increase. Other resonant circuits formed using other components are also possible. As another non-limiting example, a capacitor may be placed in parallel between the two terminals of the coil 350. For transmit coils, a signal 358 with a frequency that substantially corresponds to the resonant frequency of the coil 352 may be an input to the coil 352.

In one embodiment, the transmitter 104 may be configured to output a time varying magnetic field with a frequency corresponding to the resonant frequency of the transmit coil 114. When the receiver is within the field 105, the time varying magnetic field may induce a current in the receive coil 118. As described above, if the receive coil 118 is configured to be resonant at the frequency of the transmit coil 118, energy may be efficiently transferred. The AC signal induced in the receive coil 118 may be rectified as described above to produce a DC signal that may be provided to charge or to power a load.

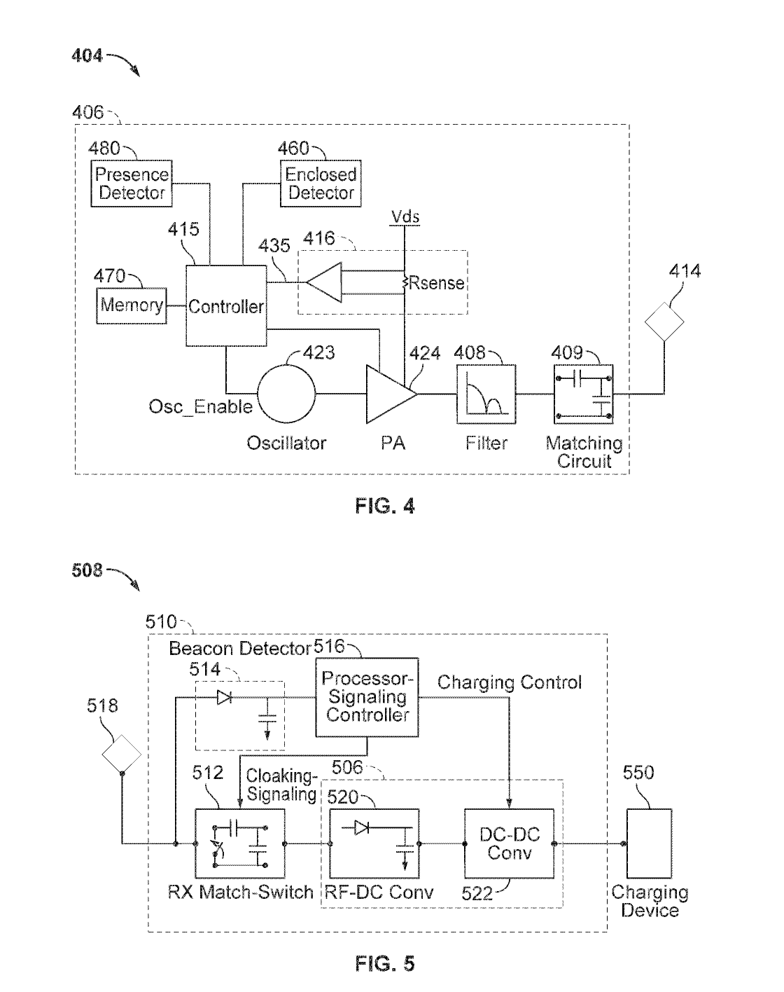

FIG. 4 is a functional block diagram of a transmitter 404 that may be used in the wireless power transfer system of FIG. 1, in accordance with exemplary embodiments of the invention. The transmitter 404 may include transmit circuitry 406 and a transmit coil 414. The transmit coil 414 may be the coil 352 as shown in FIG. 3. Transmit circuitry 406 may provide RF power to the transmit coil 414 by providing an oscillating signal resulting in generation of energy (e.g., magnetic flux) about the transmit coil 414. Transmitter 404 may operate at any suitable frequency. By way of example, transmitter 404 may operate at the 13.56 MHz ISM band.

Transmit circuitry 406 may include a fixed impedance matching circuit 409 for matching the impedance of the transmit circuitry 406 (e.g., 50 ohms) to the transmit coil 414 and a low pass filter (LPF) 408 configured to reduce harmonic emissions to levels to prevent self-jamming of devices coupled to receivers 108 (FIG. 1). Other exemplary embodiments may include different filter topologies, including but not limited to, notch filters that attenuate specific frequencies while passing others and may include an adaptive impedance match, that may be varied based on measurable transmit metrics, such as output power to the coil 414 or DC current drawn by the driver circuit 424. Transmit circuitry 406 further includes a driver circuit 424 configured to drive an RF signal as determined by an oscillator 423. The transmit circuitry 406 may be comprised of discrete devices or circuits, or alternately, may be comprised of an integrated assembly. An exemplary RF power output from transmit coil 414 may be on the order of 2.5 Watts.

Transmit circuitry 406 may further include a controller 415 for selectively enabling the oscillator 423 during transmit phases (or duty cycles) for specific receivers, for adjusting the frequency or phase of the oscillator 423, and for adjusting the output power level for implementing a communication protocol for interacting with neighboring devices through their attached receivers. It is noted that the controller 415 may also be referred to herein as processor 415. Adjustment of oscillator phase and related circuitry in the transmission path may allow for reduction of out of band emissions, especially when transitioning from one frequency to another.

The transmit circuitry 406 may further include a load sensing circuit 416 for detecting the presence or absence of active receivers in the vicinity of the near-field generated by transmit coil 414. By way of example, a load sensing circuit 416 monitors the current flowing to the driver circuit 424, that may be affected by the presence or absence of active receivers in the vicinity of the field generated by transmit coil 414 as will be further described below. Detection of changes to the loading on the driver circuit 424 are monitored by controller 415 for use in determining whether to enable the oscillator 423 for transmitting energy and to communicate with an active receiver. As described more fully below, a current measured at the driver circuit 424 may be used to determine whether an invalid device is positioned within a wireless power transfer region of the transmitter 404.

The transmit coil 414 may be implemented with a Litz wire or as an antenna strip with the thickness, width and metal type selected to keep resistive losses low. In a one implementation, the transmit coil 414 may generally be configured for association with a larger structure such as a table, mat, lamp or other less portable configuration. Accordingly, the transmit coil 414 generally may not need “turns” in order to be of a practical dimension. An exemplary implementation of a transmit coil 414 may be “electrically small” (i.e., fraction of the wavelength) and tuned to resonate at lower usable frequencies by using capacitors to define the resonant frequency.

The transmitter 404 may gather and track information about the whereabouts and status of receiver devices that may be associated with the transmitter 404. Thus, the transmit circuitry 406 may include a presence detector 480, an enclosed detector 460, or a combination thereof, connected to the controller 415 (also referred to as a processor herein). The controller 415 may adjust an amount of power delivered by the driver circuit 424 in response to presence signals from the presence detector 480 and the enclosed detector 460. The transmitter 404 may receive power through a number of power sources, such as, for example, an AC-DC converter (not shown) to convert conventional AC power present in a building, a DC-DC converter (not shown) to convert a conventional DC power source to a voltage suitable for the transmitter 404, or directly from a conventional DC power source (not shown).

As a non-limiting example, the presence detector 480 may be a motion detector utilized to sense the initial presence of a device to be charged that is inserted into the coverage area of the transmitter 404. After detection, the transmitter 404 may be turned on and the RF power received by the device may be used to toggle a switch on the Rx device in a pre-determined manner, which in turn results in changes to the driving point impedance of the transmitter 404.

As another non-limiting example, the presence detector 480 may be a detector capable of detecting a human, for example, by infrared detection, motion detection, or other suitable means. In some exemplary embodiments, there may be regulations limiting the amount of power that a transmit coil 414 may transmit at a specific frequency. In some cases, these regulations are meant to protect humans from electromagnetic radiation. However, there may be environments where a transmit coil 414 is placed in areas not occupied by humans, or occupied infrequently by humans, such as, for example, garages, factory floors, shops, and the like. If these environments are free from humans, it may be permissible to increase the power output of the transmit coil 414 above the normal power restrictions regulations. In other words, the controller 415 may adjust the power output of the transmit coil 414 to a regulatory level or lower in response to human presence and adjust the power output of the transmit coil 414 to a level above the regulatory level when a human is outside a regulatory distance from the electromagnetic field of the transmit coil 414.

As a non-limiting example, the enclosed detector 460 (may also be referred to herein as an enclosed compartment detector or an enclosed space detector) may be a device such as a sense switch for determining when an enclosure is in a closed or open state. When a transmitter is in an enclosure that is in an enclosed state, a power level of the transmitter may be increased.

In exemplary embodiments, a method by which the transmitter 404 does not remain on indefinitely may be used. In this case, the transmitter 404 may be programmed to shut off after a user-determined amount of time. This feature prevents the transmitter 404, notably the driver circuit 424, from running long after the wireless devices in its perimeter are fully charged. This event may be due to the failure of the circuit to detect the signal sent from either the repeater or the receive coil that a device is fully charged. To prevent the transmitter 404 from automatically shutting down if another device is placed in its perimeter, the transmitter 404 automatic shut off feature may be activated only after a set period of lack of motion detected in its perimeter. The user may be able to determine the inactivity time interval, and change it as desired. As a non-limiting example, the time interval may be longer than that needed to fully charge a specific type of wireless device under the assumption of the device being initially fully discharged.

FIG. 5 is a functional block diagram of a receiver 508 that may be used in the wireless power transfer system of FIG. 1, in accordance with exemplary embodiments of the invention. The receiver 508 includes receive circuitry 510 that may include a receive coil 518. Receiver 508 further couples to device 550 for providing received power thereto. It should be noted that receiver 508 is illustrated as being external to device 550 but may be integrated into device 550. Energy may be propagated wirelessly to receive coil 518 and then coupled through the rest of the receive circuitry 510 to device 550. By way of example, the charging device may include devices such as mobile phones, portable music players, laptop computers, tablet computers, computer peripheral devices, communication devices (e.g., Bluetooth devices), digital cameras, hearing aids (an other medical devices), and the like.

Receive coil 518 may be tuned to resonate at the same frequency, or within a specified range of frequencies, as transmit coil 414 (FIG. 4). Receive coil 518 may be similarly dimensioned with transmit coil 414 or may be differently sized based upon the dimensions of the associated device 550. By way of example, device 550 may be a portable electronic device having diametric or length dimension smaller that the diameter of length of transmit coil 414. In such an example, receive coil 518 may be implemented as a multi-turn coil in order to reduce the capacitance value of a tuning capacitor (not shown) and increase the receive coil's impedance. By way of example, receive coil 518 may be placed around the substantial circumference of device 550 in order to maximize the coil diameter and reduce the number of loop turns (i.e., windings) of the receive coil 518 and the inter-winding capacitance.

Receive circuitry 510 may provide an impedance match to the receive coil 518. Receive circuitry 510 includes power conversion circuitry 506 for converting a received RF energy source into charging power for use by the device 550. Power conversion circuitry 506 includes an RF-to-DC converter 520 and may also in include a DC-to-DC converter 522. RF-to-DC converter 520 rectifies the RF energy signal received at receive coil 518 into a non-alternating power with an output voltage represented by V_{rect}. The DC-to-DC converter 522 (or other power regulator) converts the rectified RF energy signal into an energy potential (e.g., voltage) that is compatible with device 550 with an output voltage and output current represented by Vₒᵤₜ and Iₒᵤₜ. Various RF-to-DC converters are contemplated, including partial and full rectifiers, regulators, bridges, doublers, as well as linear and switching converters.

Receive circuitry 510 may further include switching circuitry 512 for connecting receive coil 518 to the power conversion circuitry 506 or alternatively for disconnecting the power conversion circuitry 506. Disconnecting receive coil 518 from power conversion circuitry 506 not only suspends charging of device 550, but also changes the “load” as “seen” by the transmitter 404 (FIG. 2).

As disclosed above, transmitter 404 includes load sensing circuit 416 that may detect fluctuations in the bias current provided to transmitter driver circuit 424. Accordingly, transmitter 404 has a mechanism for determining when receivers are present in the transmitter's near-field.

When multiple receivers 508 are present in a transmitter's near-field, it may be desirable to time-multiplex the loading and unloading of one or more receivers to enable other receivers to more efficiently couple to the transmitter. A receiver 508 may also be cloaked in order to eliminate coupling to other nearby receivers or to reduce loading on nearby transmitters. This “unloading” of a receiver is also known herein as a “cloaking.” Furthermore, this switching between unloading and loading controlled by receiver 508 and detected by transmitter 404 may provide a communication mechanism from receiver 508 to transmitter 404 as is explained more fully below. Additionally, a protocol may be associated with the switching that enables the sending of a message from receiver 508 to transmitter 404. By way of example, a switching speed may be on the order of 100 μsec.

In an exemplary embodiment, communication between the transmitter 404 and the receiver 508 refers to a device sensing and charging control mechanism, rather than conventional two-way communication (i.e., in band signaling using the coupling field). In other words, the transmitter 404 may use on/off keying of the transmitted signal to adjust whether energy is available in the near-field. The receiver may interpret these changes in energy as a message from the transmitter 404. From the receiver side, the receiver 508 may use tuning and de-tuning of the receive coil 518 to adjust how much power is being accepted from the field. In some cases, the tuning and de-tuning may be accomplished via the switching circuitry 512. The transmitter 404 may detect this difference in power used from the field and interpret these changes as a message from the receiver 508. It is noted that other forms of modulation of the transmit power and the load behavior may be utilized.

Receive circuitry 510 may further include signaling detector and beacon circuitry 514 used to identify received energy fluctuations, that may correspond to informational signaling from the transmitter to the receiver. Furthermore, signaling and beacon circuitry 514 may also be used to detect the transmission of a reduced RF signal energy (i.e., a beacon signal) and to rectify the reduced RF signal energy into a nominal power for awakening either un-powered or power-depleted circuits within receive circuitry 510 in order to configure receive circuitry 510 for wireless charging.

Receive circuitry 510 further includes processor 516 for coordinating the processes of receiver 508 described herein including the control of switching circuitry 512 described herein. Cloaking of receiver 508 may also occur upon the occurrence of other events including detection of an external wired charging source (e.g., wall/USB power) providing charging power to device 550. Processor 516, in addition to controlling the cloaking of the receiver, may also monitor beacon circuitry 514 to determine a beacon state and extract messages sent from the transmitter 404. Processor 516 may also adjust the DC-to-DC converter 522 for improved performance.

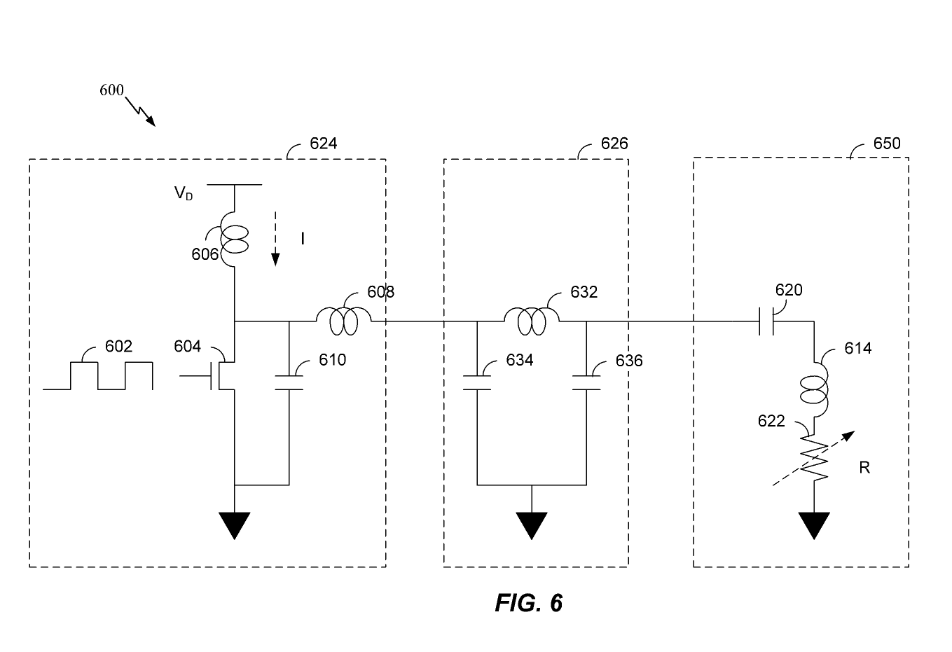

FIG. 6 is a schematic diagram of a portion of transmit circuitry 600 that may be used in the transmit circuitry 406 of FIG. 4. The transmit circuitry 600 may include a driver circuit 624 as described above in FIG. 4. As described above, the driver circuit 624 may be a switching amplifier that may be configured to receive a square wave and output a sine wave to be provided to the transmit circuit 650. In some cases the driver circuit 624 may be referred to as an amplifier circuit. The driver circuit 624 is shown as a class E amplifier, however, any suitable driver circuit 624 may be used in accordance with embodiments of the invention. The driver circuit 624 may be driven by an input signal 602 from an oscillator 423 as shown in FIG. 4. The driver circuit 624 may also be provided with a drive voltage V_{D} that is configured to control the maximum power that may be delivered through a transmit circuit 650. To eliminate or reduce harmonics, the transmit circuitry 600 may include a filter circuit 626. The filter circuit 626 may be a three pole (capacitor 634, inductor 632, and capacitor 636) low pass filter circuit 626.

The signal output by the filter circuit 626 may be provided to a transmit circuit 650 comprising a coil 614. The transmit circuit 650 may include a series resonant circuit having a capacitance 620 and inductance (e.g., that may be due to the inductance or capacitance of the coil or to an additional capacitor component) that may resonate at a frequency of the filtered signal provided by the driver circuit 624. The load of the transmit circuit 650 may be represented by the variable resistor 622. The load may be a function of a wireless power receiver 508 that is positioned to receive power from the transmit circuit 650.

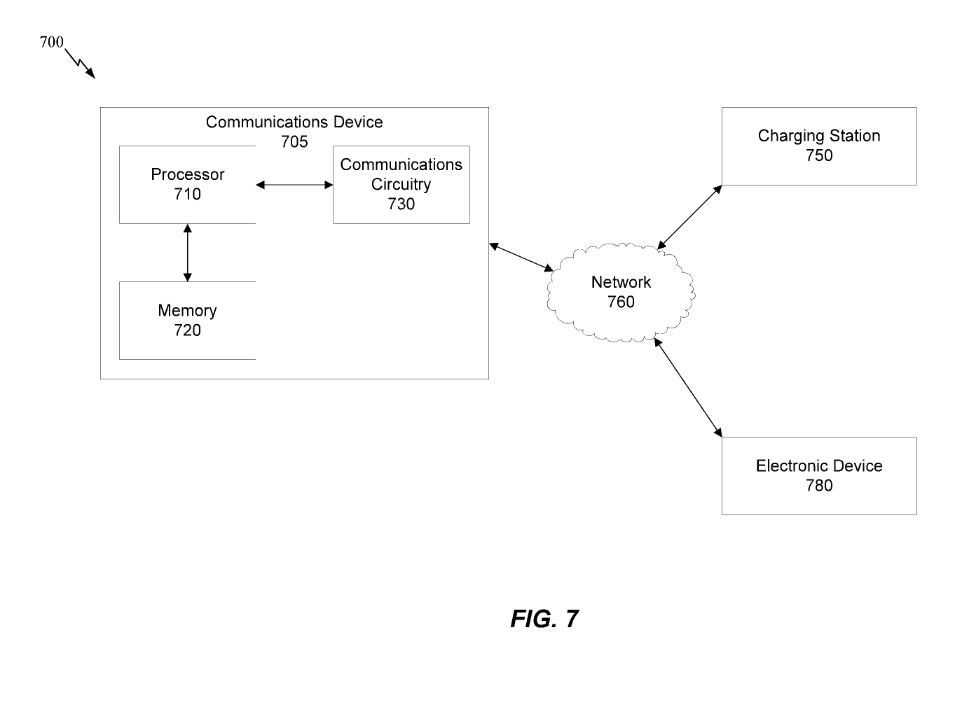

FIG. 7 illustrates an embodiment of a communications system 700. The communications system 700 may include a communications device 705, a charging station 750, a network 760, and/or an electronic device 780. The communications device 705 may include a processor 710, a memory 720, and/or communications circuitry 730. In an embodiment, the communications device 705 is configured to control the available functionality of the electronic device 780, a navigation system of a vehicle, and/or an entertainment system (e.g., an infotainment system) of a vehicle. The communications device 705 may also be configured to facilitate communications between the electronic device 780 and the navigation system and/or entertainment system of the vehicle.

In an embodiment, the communications circuitry 730 is coupled to the processor 710 and is configured to control the electronic device 780, the navigation system of a vehicle, and/or the entertainment system of the vehicle. For example, the communications circuitry 730 may be used to receive communications from the electronic device 780, the navigation system, and/or the entertainment system and to transmit control signals to the electronic device 780, the navigation system, and/or the entertainment system.

In further embodiments, the communications circuitry 730 is configured to facilitate communication between the electronic device 780 and the navigation and/or entertainment system of a vehicle. For example, the communications circuitry 730 may be used to receive communications (e.g., control signals) from the electronic device 780 and to transmit the received control signals to the navigation system and/or the entertainment system.

In some embodiments, as described herein, the communications circuitry 730 is also configured to communicate with the charging station 750 to receive charging information from the charging station 750.

In an embodiment, the processor 710 is configured to determine an entity (e.g., a person) associated with the electronic device 780 that is being charged by the charging station 750. For example, the processor 710 may determine the entity by communicating directly with the electronic device 780 or by receiving communications from the charging station 750. As an example, communications from the charging station 750 may include which charging station, if more than one exist in the communications system 700, is charging the electronic device 780. As described herein, based on determining which charging station 750 is charging the electronic device 780, the processor 710 determines the entity associated with the electronic device 780.

In an embodiment, the processor 710 may be configured to generate control signals to configure the available functionality of the electronic device 780, a navigation system, and/or an entertainment system of a vehicle. As an example, the content of the control signals may depend on the entity associated with the electronic device 780 and the control signals may be sent to the electronic device 780, navigation system, and/or entertainment system once the charging station 750 begins charging the electronic device 780. The control signals (e.g., instructions) may be stored in the memory 720 and may be transmitted to the appropriate device or system using the communications circuitry 730.

The communications device 705 may be in communication with the charging station 750 and/or the electronic device 780 via the network 760. The network 760 may include any communications network. Network 760 may be a wired network, a wireless network, or a combination of the two. For example, the network 760 may be a local area network (LAN), a wide area network (WAN), the Internet, and/or combinations of the same.

In an embodiment, the charging station 750 is configured to transfer power wirelessly to the electronic device 780 at a level sufficient to charge or power the electronic device 780. The charging station 750 may include transmit circuitry, such as transmit circuitry 600 of FIG. 6, to transfer the power wirelessly to the electronic device 780. Likewise, the electronic device 780 may include receive circuitry, such as receive circuitry 510 of FIG. 5, to receive the power wirelessly from the charging station 750.

In some embodiments, the charging station 750 includes a detector configured to detect the presence of the electronic device 780. The detector 750 may include any type of sensor, the outputs of which could be used to detect the electronic device 780 (e.g., a motion detector, a weight scale, an electronic sensor including communication circuitry, etc.). In other embodiments, the communications device 705 includes the detector.

In an embodiment, the charging station 750 includes additional transmit and receive circuitry for communicating with the communications device 705 via the network 760. For example, the charging station 750 may use the additional transmit and receive circuitry to notify the communications device 705 that the charging device 780 has been detected, that charging of the electronic device 780 has been initiated, that charging of the electronic device 780 has ceased, and/or that the charging device 780 is no longer detected.

In some embodiments, not shown, the functionality of the communications device 705 and the charging station 750 are combined and performed by a single device or system (e.g., a wireless power and communications system)

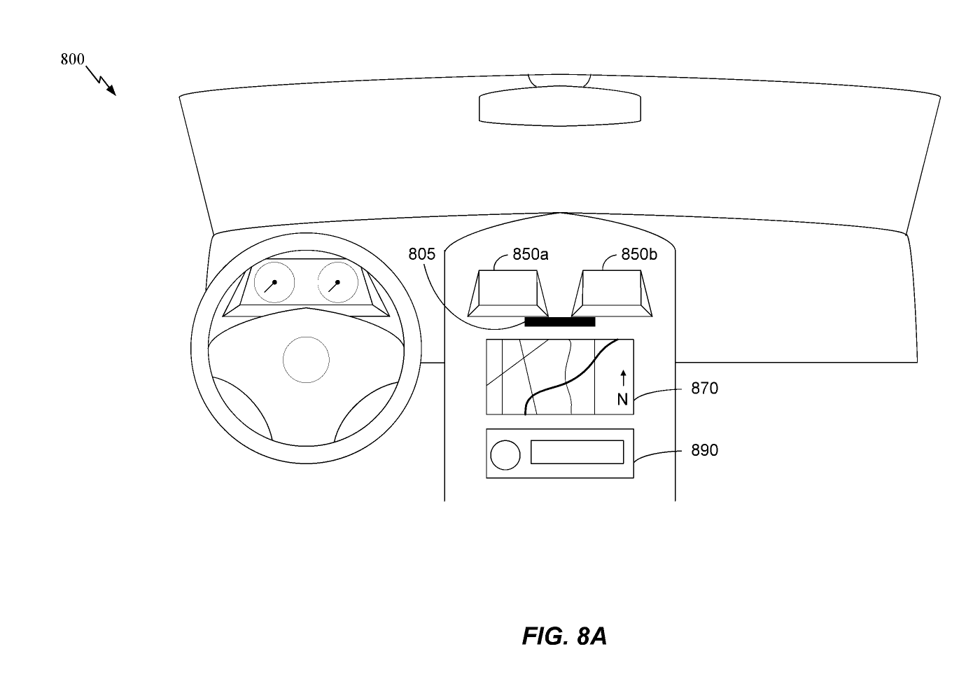

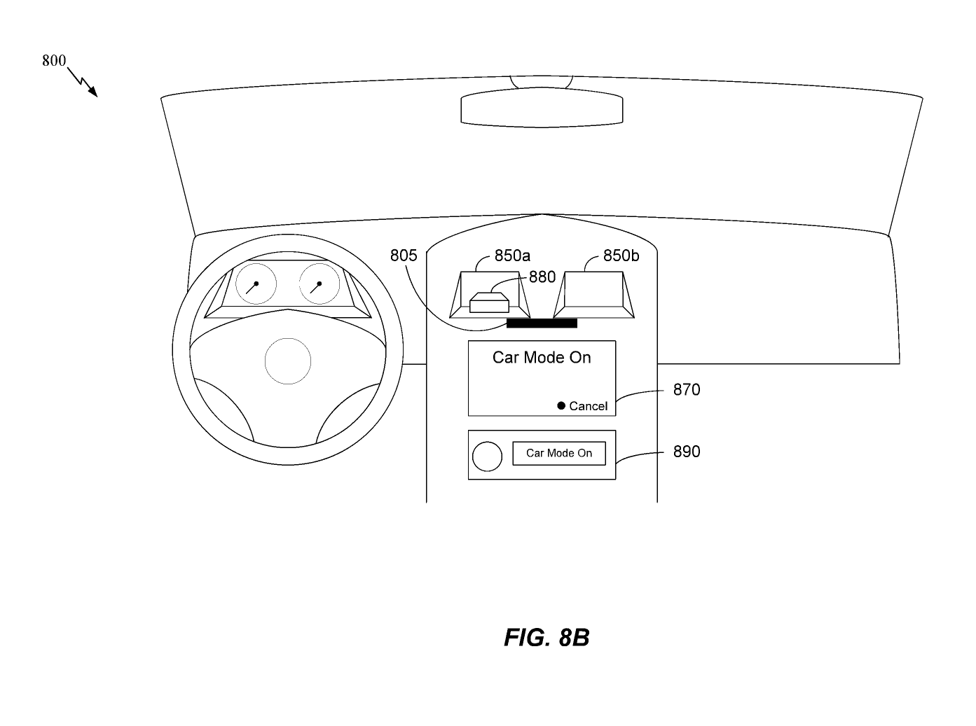

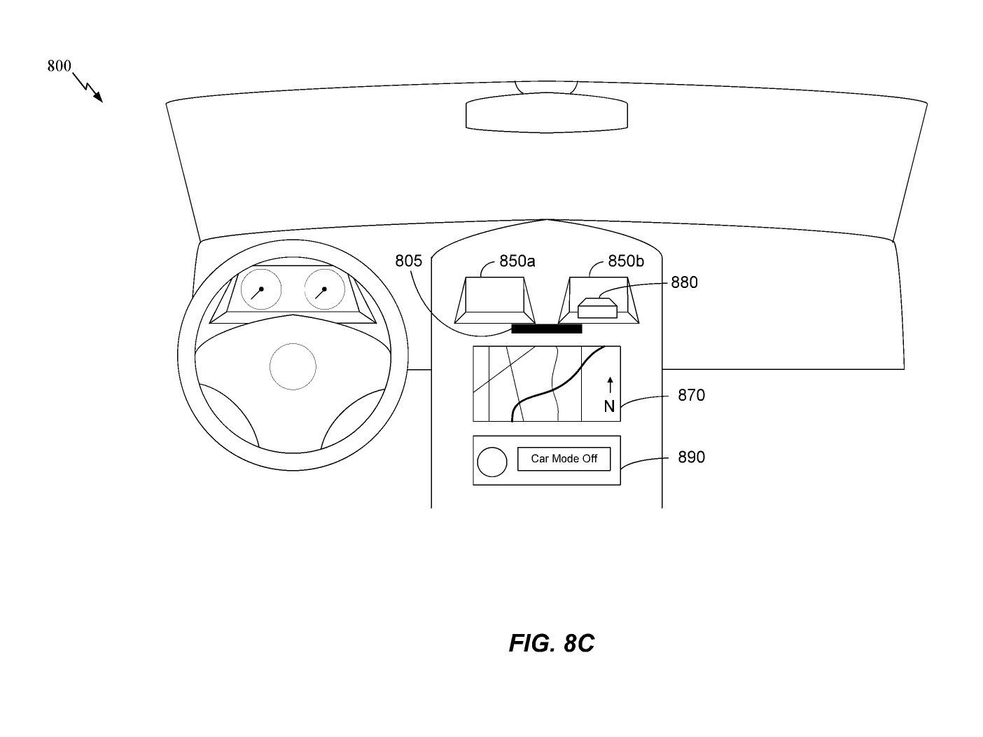

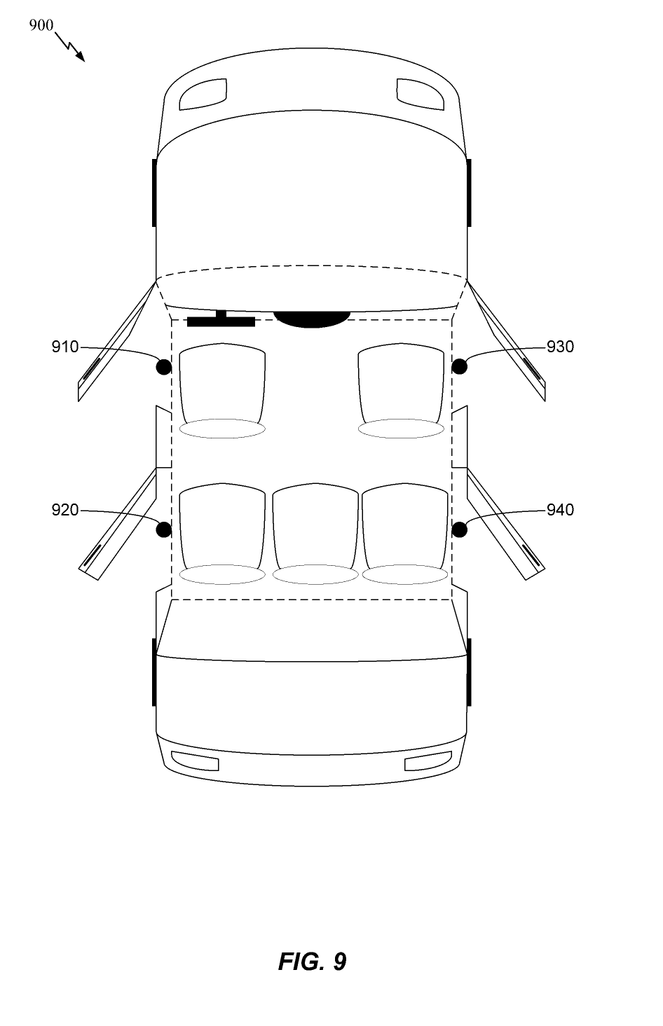

FIGS. 8A-C illustrate an embodiment of an interior 800 of a vehicle. In an embodiment, the interior 800 includes a communications device 805, a charging station 850a, a charging station 850b, a navigation system 870 and/or an entertainment system 890. While two charging stations 850a-b are illustrated within a center console of the interior 800, any number of charging stations may be included in any location within or proximate to the interior 800.

In an embodiment, the communication device 805 may be located near the charging stations 850a and 850b. For example, in a vehicle, the communications device 805 may be located in the center console above (not shown) or below the charging stations 850a and 850b. The communications device 805 may function as an interface between an electronic device, such as the electronic device 880 as illustrated in FIGS. 8B-C, and the navigation system 870 and/or the entertainment system 890 (e.g., a car infotainment system). The electronic device 880 may communicate with the communications device 805 using any wired or wireless technology, such as Bluetooth, WiFi, RF, USB, or the like. By establishing communication between the electronic device 880 and the communications device 805, a user may be able to control the navigation system 870 and/or the entertainment system 890 using the electronic device 880.

In an embodiment, once the electronic device 880 is placed in an alcove of the charging station 850a or 850b, the electronic device 880 may be automatically paired with the communications device 805. In addition, once the electronic device 880 is placed in an alcove, the charging station 850a or 850b may initiate charging of the electronic device 880. Once the electronic device 880 is removed from the alcove, the electronic device 880 may be unpaired from the communications device 805 and/or the charging station 850a or 850b may terminate charging of the electronic device 880. In this way, the electronic device 880, based on its location, may be automatically charged, connected to the navigation system 870 and/or entertainment system 890, and/or disconnected from the navigation system 870 and/or entertainment system 890 without a user having to interact with the electronic device 880 in any way.

In some embodiments, based on which alcove the electronic device 880 is placed in, the communications device 805 may also modify behavior of the electronic device 880. For example, if the electronic device 880 is placed in an alcove closer to the driver-side of a vehicle (e.g., the device belongs to the driver) as illustrated in FIG. 8B, the communications device 805 may transmit a command or otherwise cause the electronic device 880 to switch into a restricted-use mode (e.g., a car-mode, a plane-mode, etc.). In the restricted-use mode, functionality of the electronic device 880 may be restricted such that the electronic device 880 only performs operations that would not be distracting to a user (e.g., certain operations may be disabled). For example, in a restricted-use mode, the electronic device 880 may not allow texting or communications with a network, but may allow access to entertainment controls. If the electronic device 880 is then removed from the alcove closer to the driver-side of the vehicle (e.g., removed from the charging station 850a), the electronic device 880 may be switched out of the restricted-use mode such that the user can use the full functionality of the electronic device 880.

In another example, if the electronic device 880 is placed in an alcove closer to the passenger-side of the vehicle (i.e., the device belongs to a passenger) as illustrated in FIG. 8C, the communications device 805 may not transmit a command or otherwise cause the electronic device 880 to switch into a restricted-use mode. In other words, if the electronic device 880 is placed in an alcove closer to the passenger-side of the vehicle (e.g., in charging station 850b), a user may continue to interact with the electronic device 805 without any restrictions. In this way, the communications device 805 may be able to identify the possessor of a device (e.g., a driver or a passenger) and change a behavior of the electronic device 880 based on the identified possessor.

Likewise, based on which alcove the electronic device 880 is placed in, the communications device 805 may also modify behavior of the navigation system 870 and/or the entertainment system 890. For example, if the electronic device 880 is placed in the alcove of charging station 850a, the communications device 805 may configure the available functionality of the navigation system 870 and/or the entertainment system 890 such that certain controls that may be distracting to a user may be disabled. If the electronic device 880 is placed in the alcove of charging station 850b, the communications device 805 may not configure or change the available functionality of the navigation system 870 and/or the entertainment system 890.

FIG. 9 illustrates an embodiment of a vehicle 900. The vehicle 900 may include sensors 910, 920, 930, and/or 940. In some embodiments, the additional sensors 910, 920, 930, and/or 940 are placed in locations near the charging stations 850a and/or 850b and/or near the communications device 805 identify the possessor of the electronic device 880. For example, in the vehicle 900, the additional sensors 910, 920, 930, and/or 940 may be placed near or on the doors and may be configured to detect from which side of the vehicle 900 the electronic device 880 entered the vehicle 900. The communications device 805 may be configured to receive data from the additional sensors 910, 920, 930, and/or 940 and determine the possessor of the electronic device 880 based on which side the electronic device 880 entered the vehicle 900 (e.g., if the electronic device 880 entered the vehicle 900 via a front driver-side door, then the possessor of the electronic device 880 is considered to be the driver, whereas if the electronic device 880 entered the vehicle 900 via any other door, then the possessor of the electronic device 880 is considered to be a passenger). The communications device 805 may then change the behavior of the electronic device 880 as described herein.

In further embodiments, the additional sensors 910, 920, 930, and/or 940 may also be configured to detect a number of persons near the charging stations 850a and/or 850b and/or near the communications device 805. For example, the additional sensors 910, 920, 930, and/or 940 may be configured to detect a number of persons in the vehicle 900. If a single person is detected inside or near the vehicle 900, then the communications device 805 may assume that the electronic device 880 belongs to a driver and switch the electronic device 880 into a restricted-use mode, regardless of which alcove the electronic device 880 is placed in.

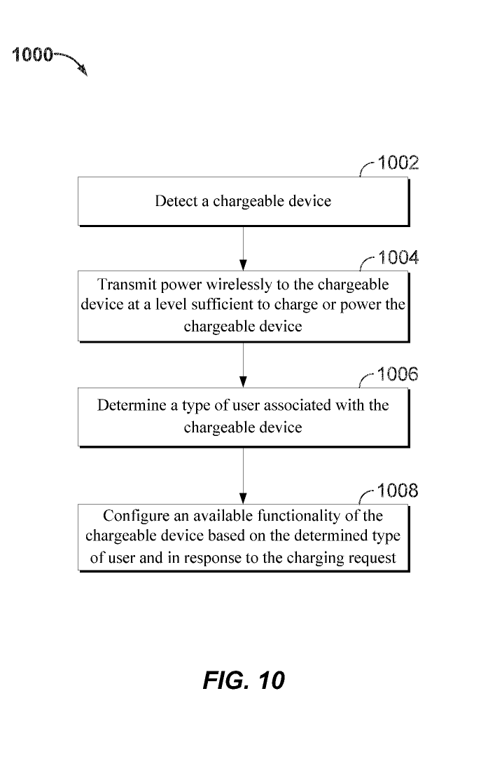

FIG. 10 is a flowchart of an exemplary method 1000 of transferring power wirelessly for charging. In an embodiment, the steps in flowchart 1000 may be performed by the communications device 705 and charging station 750 discussed above with respect to FIG. 7. Although the method of flowchart 1000 is described herein with reference to a particular order, in various embodiments, blocks herein may be performed in a different order, or omitted, and additional blocks may be added. A person having ordinary skill in the art will appreciate that the method of flowchart 1000 may be implemented in any communication device that may be configured to transmit power to a wireless power receiver of an electronic device and communicate with the electronic device.

At block 1002, the method 1000 detects a chargeable device. In an embodiment, the chargeable device has an available functionality and is configured to initiate a charging request. At block 1004, the method 1000 transmits power wirelessly to the chargeable device at a level sufficient to charge or power the chargeable device. At block 1006, the method 1000 determines a type of user associated with the chargeable device. For example, the determination may be made based on the location of the chargeable device. At block 1008, the method 1000 configures the available functionality of the chargeable device based on the determined type of user and in response to the charging request.

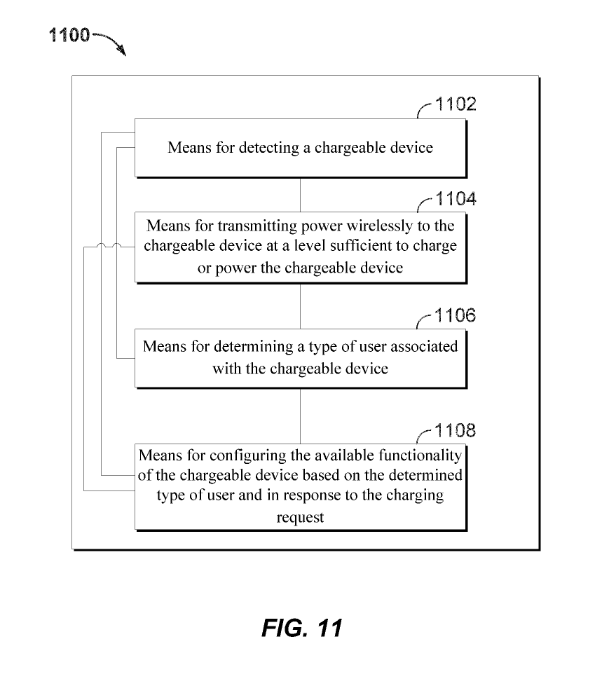

FIG. 11 is a functional block diagram of a wireless power and communications system 1100, in accordance with an exemplary embodiment of the disclosure. Wireless power and communications system 1100 comprises means 1102, means 1104, means 1106, and means 1108 for the various actions discussed with respect to FIGS. 1-10. The system 1100 includes means 1102 for detecting a chargeable device. In an embodiment, means 1102 for detecting a chargeable device may be configured to perform one or more of the functions discussed above with respect to block 1002. The system 1100 further includes means 1104 for transmitting power wirelessly to the chargeable device at a level sufficient to charge or power the chargeable device. In an embodiment, means 1104 for transmitting power wirelessly to the chargeable device at a level sufficient to charge or power the chargeable device may be configured to perform one or more of the functions discussed above with respect to block 1004. The system 1100 further includes means 1106 for determining a type of user associated with the chargeable device. In an embodiment, means 1106 for determining a type of user associated with the chargeable device may be configured to perform one or more of the functions discussed above with respect to block 1006. The system 1100 further includes means 1108 for configuring the available functionality of the chargeable device based on the determined type of user and in response to the charging request. In an embodiment, means 1108 for configuring the available functionality of the chargeable device based on the determined type of user and in response to the charging request may be configured to perform one or more of the functions discussed above with respect to block 1008.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations. Means for detecting may be provided by a detector. Means for transmitting power may be provided by a transmitter. Means for determining may be provided by a processor. Means for configuring may be provided by the processor.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the embodiments of the invention.

The various illustrative blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk and blu ray disc where disks usually reproduce data magnetically, while discs reproduce data optically with lasers. Combinations of the above should also be included within the scope of computer readable media. The processor and the storage medium may reside in an ASIC. The ASIC may reside in a user terminal. In the alternative, the processor and the storage medium may reside as discrete components in a user terminal.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

Various modifications of the above described embodiments will be readily apparent, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system for transferring power wirelessly for charging a chargeable device, comprising:
a detector configured to detect the chargeable device, the chargeable device having an available functionality and configured to initiate a charging request;
a wireless power transmitter operationally coupled to the detector and configured to transmit power wirelessly to the chargeable device at a level sufficient to charge or power the chargeable device; and
a processor configured to determine a type of user associated with the chargeable device and to configure the available functionality of the chargeable device based on the determined type of user and in response to the charging request.

2. The system of claim 1, wherein the processor is further configured to determine the type of user associated with the chargeable device based on a location of the chargeable device.

3. The system of claim 1, wherein the processor is further configured to determine the type of user associated with the chargeable device based on a surface in contact with the chargeable device.

4. The system of claim 1, wherein the wireless power transmitter is configured to transmit power wirelessly to the chargeable device to charge the chargeable device when the chargeable device is located in a first location or an alternate location.

5. The system of claim 4, wherein the processor is further configured to pair the chargeable device with an infotainment system and restrict functionality of the chargeable device if the chargeable device is located in the first location.

6. The system of claim 5, wherein the processor is further configured to unpair the chargeable device from the infotainment system and remove the restriction on functionality of the chargeable device if the chargeable device is removed from the first location.

7. The system of claim 4, wherein the processor is further configured to pair the chargeable device with an infotainment system and not restrict the available functionality of the chargeable device if the chargeable device is located in the alternate location.

8. The system of claim 1, wherein the detector and the processor are located in a vehicle.

9. The system of claim 8, further comprising a sensor configured to detect a side of the vehicle from which the chargeable device entered.

10. The system of claim 9, wherein the processor is further configured to restrict the available functionality of the chargeable device based on the detected side.

11. The system of claim 8, further comprising a sensor configured to detect a number of persons in the vehicle, wherein the processor is further configured to restrict the available functionality of the chargeable device if one person is detected in the vehicle.

12. A method of transferring power wirelessly for charging a chargeable device, comprising:
detecting the chargeable device, the chargeable device having an available functionality and configured to initiate a charging request;
transmitting power wirelessly to the chargeable device at a level sufficient to charge or power the chargeable device;
determining a type of user associated with the chargeable device; and
configuring the available functionality of the chargeable device based on the determined type of user and in response to the charging request.

13. The method of claim 12, further comprising determining the type of user associated with the chargeable device based on a location of the chargeable device.

14. The method of claim 12, further comprising determining the type of user associated with the chargeable device based on a surface in contact with the chargeable device.

15. The method of claim 12, wherein the transmitting power wirelessly further comprises transmitting power wirelessly to the chargeable device to charge the chargeable device when the chargeable device is located in a first location or an alternate location.

16. The method of claim 15, further comprising:
pairing the chargeable device with an infotainment system; and
restricting the available functionality of the chargeable device if the chargeable device is located in the first location.

17. The method of claim 16, further comprising:
unpairing the chargeable device from the infotainment system; and
removing the restriction on the available functionality of the chargeable device if the chargeable device is removed from the first location.

18. The method of claim 15, further comprising:
pairing the chargeable device with an infotainment system; and not
restricting the available functionality of the chargeable device if the chargeable device is located in the alternate location.

19. The method of claim 12, further comprising detecting a side of a vehicle from which the chargeable device entered.

20. The method of claim 19, further comprising restricting the available functionality of the chargeable device based on the detected side.

21. The method of claim 12, further comprising detecting a number of persons in a vehicle.

22. The method of claim 21, further comprising restricting the available functionality of the chargeable device if one person is detected in the vehicle.

23. An apparatus for transferring power wirelessly for charging a chargeable device, comprising:
means for detecting the chargeable device, the chargeable device having an available functionality and configured to initiate a charging request;
means for transmitting power wirelessly to the chargeable device at a level sufficient to charge or power the chargeable device;
means for determining a type of user associated with the chargeable device; and
means for configuring the available functionality of the chargeable device based on the determined type of user and in response to the charging request.

24. The apparatus of claim 23, wherein the means for transmitting power wirelessly further comprises means for transmitting power wirelessly to the charging device to charge the charging device when the charging device is located in a first location or an alternate location.

25. The apparatus of claim 24, further comprising:
means for pairing the chargeable device with an infotainment system; and
means for restricting the available functionality of the chargeable device if the chargeable device is located in the first location.

26. The apparatus of claim 25, further comprising:
means for unpairing the chargeable device from the infotainment system; and
means for removing the restriction on the available functionality of the chargeable device if the chargeable device is removed from the first location.

27. The apparatus of claim 24, further comprising:
means for pairing the chargeable device with an infotainment system; and not
means for restricting the available functionality of the chargeable device if the chargeable device is located in the alternate location.

28. The apparatus of claim 23, wherein the means for detecting comprises a detector, wherein the means for transmitting comprises a transmitter, and wherein the means for determining and the means for configuring comprise a processor.

29. A non-transitory computer-readable medium comprising code that, when executed, causes an apparatus to:
detect a chargeable device, the chargeable device having an available functionality and configured to initiate a charging request;
transmit power wirelessly to the chargeable device at a level sufficient to charge or power the chargeable device;
determine a type of user associated with the chargeable device; and
configure the available functionality of the chargeable device based on the determined type of user in response to the charging request.

30. The medium of claim 29, further comprising code that, when executed, causes an apparatus to determine the type of user associated with the chargeable device based on a location of the chargeable device.

31. The medium of claim 29, further comprising code that, when executed, causes an apparatus to determine the type of user associated with the chargeable device based on a surface in contact with the chargeable device.

32. The medium of claim 29, further comprising code that, when executed, causes an apparatus to transmit power wirelessly to the chargeable device to charge the chargeable device when the chargeable device is located in a first location or an alternate location.

33. The medium of claim 32, further comprising code that, when executed, causes an apparatus to:
pair the chargeable device with an infotainment system; and
restrict the available functionality of the chargeable device if the chargeable device is located in the first location.

34. The medium of claim 33, further comprising code that, when executed, causes an apparatus to:
unpair the chargeable device from the infotainment system; and
remove the restriction on the available functionality of the chargeable device if the chargeable device is removed from the first location.

35. The medium of claim 32, further comprising code that, when executed, causes an apparatus to:
pair the chargeable device with an infotainment system; and not
restrict the available functionality of the chargeable device if the chargeable device is located in the alternate location.

36. The medium of claim 29, further comprising code that, when executed, causes an apparatus to detect a side of a vehicle from which the chargeable device entered.

37. The medium of claim 36, further comprising that, when executed, causes an apparatus to restrict the available functionality of the chargeable device based on the detected side.

38. The medium of claim 29, further comprising code that, when executed, causes an apparatus to detect a number of persons in a vehicle.

39. The medium of claim 38, further comprising code that, when executed, causes an apparatus to restrict the available functionality of the chargeable device if one person is detected in the vehicle.
